(19) United States
(12) Patent Application Publication
(10) Pub. No.: US 2013/0082155 A1
(43) Pub. Date: Apr. 4, 2013

(54) BASEBALL BAT SUPPORT DEVICE

(71) Applicant: Robert McCormack, Bayport, NY (US)

(72) Inventor: Robert McCormack, Bayport, NY (US)

(21) Appl. No.: 13/623,960

(22) Filed: Sep. 21, 2012

Related U.S. Application Data
(60) Provisional application No. 61/542,912, filed on Oct. 4, 2011.
(60) Provisional application No. 61/637,000, filed on Apr. 23, 2012.

(51) Int. Cl. F16M 13/02; A47F 7/00

(52) U.S. Cl. 248/220.21; 248/314

(57) ABSTRACT

A baseball bat support device includes a main body having a bat receiving pocket formed therein for removably receiving a portion of a baseball bat, a spacer affixed to the main body, and an attachment clip disposed on the spacer. The baseball bat support device is removably attachable to a chain-link fence. The spacer is wedge-shaped and is receivable within an open area of the chain-link fence. The attachment clip includes a notch foamed in its periphery which engages a wire twist link of the chain-link fence.

### CROSS-REFERENCE TO RELATED APPLICATIONS

This application is related to U.S. Provisional Application Ser. No. 61/542,912, filed on Oct. 4, 2011, and entitled “Baseball Bat Support Device” and U.S. Provisional Application Ser. No. 61/637,000, filed on Apr. 23, 2012, and also entitled “Baseball Bat Support Device”, the disclosure of each of which is incorporated herein by reference and on which priority is hereby claimed.

### BACKGROUND OF THE INVENTION

1. Field of the Invention

The present invention generally relates to an improved device to removably secure a baseball bat to a chain-link fence.

2. Description of Prior Art

Baseball bats are generally placed on a baseball field near the batter's box and the area surrounding home plate. Surrounding the area around home plate of nearly every baseball field is a chain-link fence serving as a backstop, where the baseball bats are temporarily stored prior to their use by the batter. The bats are often placed with their handles through the links of the fence, the main body of the bat extending outwardly at an angle to the fence. Alternatively, the bats are leaned up against the fence at an angle. In either case, the bats protrude from the fence, and this may cause injury to a player.

There is also known a bat holder consisting of two parallel, spaced apart, wire rods that hook onto the fence or backstop and hold a number of bats between them. This bat holder also extends outwardly from the fence which, again, may cause injury. Also, when it is desired to select a particular bat, it may be necessary for the player to remove and rearrange other bats on the holder in front of the selected bat.

### OBJECTS AND SUMMARY OF THE INVENTION

It is an object of the present invention to provide a bat holder for quickly and conveniently removably securing a regulation-sized baseball bat to a chain-link fence.

It is another object of the present invention to provide a bat holder for removably securing a baseball bat to a chain-link fence and which minimizes the bat from falling when the fence is banged on, hit or vibrated.

It is still another object of the present invention to provide a holder for holding an individual baseball bat against a chain-link fence.

It is a further object of the present invention to provide a baseball bat holder which overcomes the inherent disadvantages of conventional devices used to secure baseball bats to a fence.

In accordance with one form of the present invention, a baseball bat holder for attachment to a chain-link fence includes a main body, an open pocket fowled in the main body, a spacer affixed to the back of the main body, which may be in the form of a wedge, and an attachment clip. More specifically, the attachment clip extends from the wedge-like spacer on a rear side of the main body and removably secures the main body to the chain-link fence. The pocket is dimensioned to receive the knob end of the bat so that the bat may hang downwardly by gravity from the pocket and may be easily removed therefrom. Portions of angled surfaces of the main body which define the pocket and support the bat may be sloped rearwardly toward the rear side thereof to minimise the chance of the bat becoming dislodged inadvertently from the holder when the fence on which the bat holder is affixed is hit.

In yet another embodiment, instead of an attachment clip, the spacer may contain grooves or recesses which are dimensioned to receive and removably secure the holder to the links of the fence.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a front perspective view of one embodiment of the baseball bat support device of the present invention situated on a chain-link fence, and a baseball bat situated therein.

FIG. 2 is a front perspective view of the baseball bat support device of the present invention situated on a chain-link fence, and illustrating how a baseball bat may be placed on and held by the bat support device.

FIG. 3 is a rear perspective view of the baseball bat support device of the present invention, and illustrating how the bat support device may be affixed to a chain-link fence.

FIG. 4 is an exploded front perspective view of one form of the baseball bat support device of the present invention shown in FIG. 3.

FIG. 5 is an exploded rear perspective view of the baseball bat support device of the present invention shown in FIGS. 3 and 4.

FIG. 6 is a side view of a pocket portion of the baseball bat support device of the present invention.

FIG. 7 is a partially cutaway side view of the pocket portion of the baseball bat support device of the present invention shown in FIG. 6 and with a baseball bat situated therein, and illustrating a baseball bat supported thereby.

FIG. 8 is a rear perspective view of a second embodiment of the baseball bat support device of the present invention, and illustrating how this embodiment attaches to the fence.

FIG. 9 is partial exploded perspective view of a portion of the second embodiment of the baseball bat support device of the present invention shown in FIG. 8.

FIG. 10 is a rear perspective view of the second embodiment of the baseball bat support device of the present invention shown in FIG. 8 affixed to a chain-link fence.

FIG. 11 is a rear perspective view of a third embodiment of the baseball bat support device of the present invention, and illustrating how this embodiment of the bat support device may be affixed to a chain-link fence.

FIG. 12 is a partial exploded perspective view of a portion of the third embodiment of the baseball bat support device of the present invention shown in FIG. 11.

FIG. 13 is a rear perspective view of the third embodiment of the baseball bat support device of the present invention shown in FIG. 11 affixed to a chain-link fence.

FIG. 14 is a rear perspective view of a fourth embodiment of the baseball bat support device of the present invention, and illustrating how this embodiment of the bat support device may be affixed to a chain-link fence.

FIG. 15 is a partial exploded perspective view of a portion of the fourth embodiment of the baseball bat support device of the present invention shown in FIG. 14.

FIG. 16 is a rear perspective view of the fourth embodiment of the baseball bat support device of the present invention shown in FIG. 14 affixed to a chain-link fence.

FIG. 17 is a rear perspective view of a fifth embodiment of the baseball bat support device of the present invention, and illustrating how this embodiment of the bat support device may be affixed to a chain-link fence.

FIG. 18 is a partial exploded perspective view of a portion of the fifth embodiment of the baseball bat support device of the present invention shown in FIG. 17.

FIG. 19 is a rear perspective view of the fifth embodiment of the baseball bat support device of the present invention shown in FIG. 17 affixed to a chain-link fence.

FIG. 20 is a front perspective view of a sixth embodiment of the baseball bat support device of the present invention situated on a chain-link fence, and illustrating how a baseball bat may be placed on and held by the bat support device.

FIG. 21 is a rear perspective view of the baseball bat support device of the present invention shown in FIG. 20, and illustrating how the bat support device may be affixed to a chain-link fence.

FIG. 22 is a cross-sectional view of the baseball bat support device of the present invention shown in FIGS. 20 and 21, taken along line 22-22 of FIG. 21.

FIG. 23 is a rear perspective view of the baseball bat support device of the present invention shown in FIGS. 21 and 22 affixed to a chain-link fence.

FIG. 24 is a partial perspective view showing in detail a portion of the bat support device of the present invention shown encircled in FIG. 23 by the broken line labeled with reference no. 24.

FIG. 25 is a partial perspective view showing in detail another portion of the bat support device of the present invention shown encircled in FIG. 23 by the broken line labeled with reference no. 25.

### DETAILED DESCRIPTION OF THE PREFERRED EMBODIMENTS

Referring to FIGS. 1-19 of the drawings, it will be seen that a baseball bat support device constructed in accordance with the present invention, also referred to herein simply as a bat holder, generally includes a main body 1, a spacer 27, which may be wedge-shaped in a preferred form, and an attachment clip 5 situated on the spacer for securing the bat holder to a chain-link fence 100.

The main body 1 may take on any shape, such as rectangular or square, but is preferably generally cylindrical in shape. The main body 1 includes a front wall 52, a back wall 53 situated opposite the front wall 52, and a side wall 4 extending between the front wall 52 and the back wall 53. The main body 1 may be formed from a solid piece of material, such as rubber, wood, metal, plastic or the like, or may be hollow to define an interior cavity.

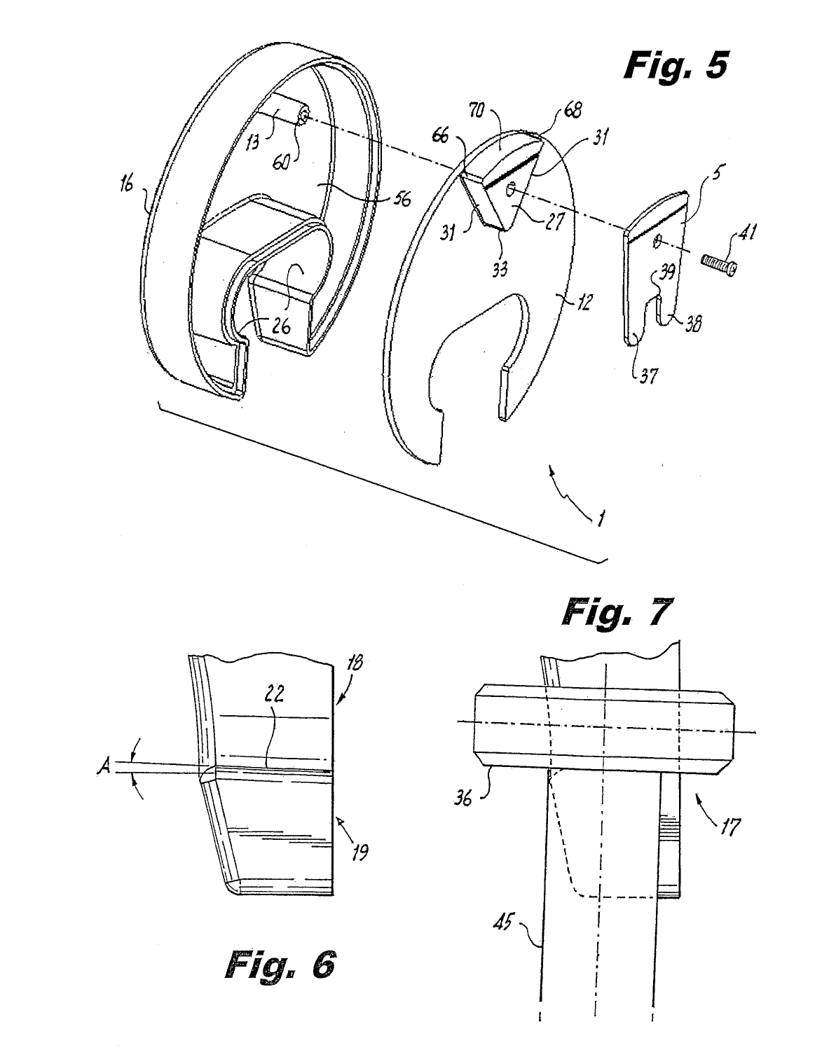

In the particular embodiment of the bat holder shown in FIGS. 1-7, and as can be clearly seen in FIGS. 4 and 5, the main body 1 is Ruined of two mating sections, that is, a front section 2 and a rear section 3. In this embodiment, and as shown in FIGS. 4 and 5, the wedge-like spacer 27 is integrally formed with the rear section 3 and extends outwardly from the back surface 12 thereof, which defines the back surface 12 of the main body 1. The front section 2 attaches to the rear section 3 at a threaded post 13 to define the main body 1. The threaded post 13 extends perpendicularly outwardly from an inner surface 56 of the front section 2 to an opening 14 formed in the rear section 3, as shown in FIG. 4, and has an interiorly threaded bore 60. The rear section 3 can then be joined to the front section 2, and the two sections 2, 3 of the main body 1 are held together by using a screw 41 passing through the opening 14 and being received by the bore 60 of the threaded post. Of course, it envisioned to be within the scope of the present invention to join the front and rear sections 2, 3 together using adhesive, other screws or bolts or any other type of means which is well known to those skilled in the art.

The front surface 16 of the main body 1 may be flat, but is preferably slightly convex in shape. Also, there is a substantial area on the front surface 16 of the main body 1 that is provided for adding a logo, advertisement or other printed, engraved or embossed writing or material if it is desired to include such. Furthermore, the back surface 12 of the main body 1 may be roughened, or formed from or include thereon a material with a high coefficient of friction, such as rubber, since the back surface of the main body 1 of the bat holder will be in contact with the chain-link fence 100 when the bat holder is mounted thereon. The roughened or high friction surface or material of the back surface 12 of the main body 1 will help stabilize the bat holder and help prevent it from swinging when the bat holder is mounted on the fence, as will be described in greater detail.

As shown in FIGS. 1-7, the main body 1 of the bat holder is formed with a pocket 17 to receive the knob 46 and a portion of the shank 45 of a baseball bat 7 supported by the bat holder. More specifically, the pocket is preferably formed through the front section 2 and the rear section 3 of the main body 1 (see FIGS. 4 and 5).

More specifically, the main body 1 defines the pocket 17 with an upper portion 18 and a lower portion 19 below the upper portion 18 and in communication therewith. The upper portion 18 has a greater width than the lower portion 19. Even more specifically, the upper portion 18 is dimensioned in width to be capable of receiving and captively holding therein the knob end 46 of the baseball bat 7. The lower portion 19 is dimensioned in width to be less than that of the upper portion 18, and more specifically has a width which is dimensioned to receive a portion of the shank 45 of the baseball bat 7 adjacent to the knob 46.

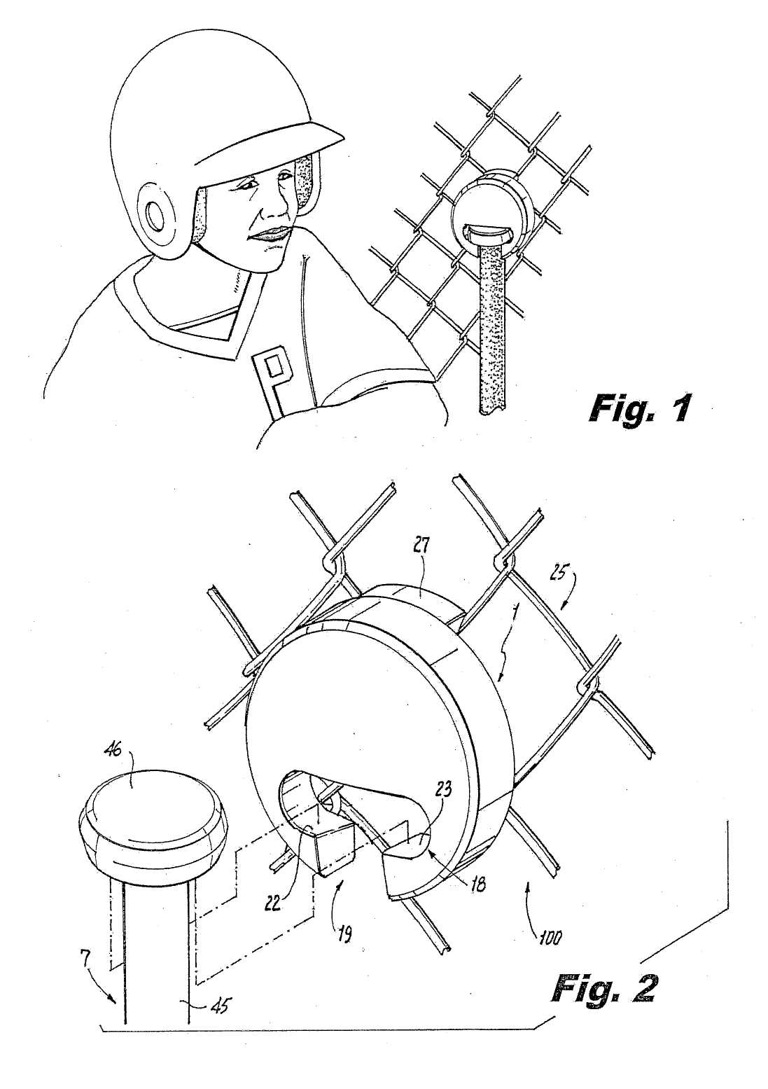

Even more particularly, and as shown in. FIG. 2 of the drawings, the main body 1 defines the upper portion 18 of the bat receiving pocket 17 with opposite and separated first and second contact surfaces 22, 23. Underside portions 36 of the knob 46 of the baseball bat rest on the first and second contact surfaces 22, 23 within the upper portion 18 of the pocket so that the baseball bat may hang by gravity from the bat holder downwardly, with the knob 46 of the bat 7 being received by the upper portion 18 of the pocket 17 and supported by the opposite first and second contact surfaces 22, 23, and the shank 45 being received within the lower portion 19 of the pocket 17.

As shown in FIGS. 1-7 of the drawings, the upper portion 18 of the pocket 17 is preferably at least partially defined by opposite rounded or curved interior side walls 26 of the main body 1. However, it should be understood that the pocket 17, and in particular the upper portion 18 of the pocket 17, may be formed in a variety of shapes and sizes, including rectangular in shape, as long as the upper portion 18 is dimensioned to receive the knob 46 of the baseball bat and securely hold the knob 46 therewithin The opposite first and second contact surfaces 22, 23 support the weight of the bat 7 and allow the bat to hang freely through the lower portion 19 of the pocket 17 as shown in FIGS. 1 and 7 of the drawings, but also allow the bat 7 to be easily removed from the pocket 17 of the bat holder from the front surface 16 of the main body 1.

As mentioned previously, the bat holder includes a spacer 27 which, in a preferred form, may be wedge-shaped. In the embodiment of the bat holder shown in FIGS. 1-7, the spacer 27 is preferably fowled integrally with the rear section 3 of the bat holder; however, in other embodiments of the present invention and as will be described in greater detail, the spacer 27 may be a separate component of the bat holder and affixed to the main body 1 by a screw 42 passing through a bore 30 formed through the thickness of the spacer 27, or by adhesive, or by any other means for fastening one device to another as is well known to one skilled in the art. The spacer 27 is situated on the back surface 12 of the main body 1, and preferably has a thickness which is dimensioned based on the overall thickness of the chain-link fence 100 on which the bat holder of the present invention is designed to be mounted.

Preferably, and as mentioned previously, the spacer 27 is shaped as a wedge such that it appears as an inverted triangle, and includes angled surfaces 31 which mutually diverge from an inverted apex 33 and which are joined at opposite ends 66, 68 of an interconnecting surface 70. The angle at which the surfaces 31 diverge from each other can vary according to the shape of the fence. Preferably, the diverging angle is about 70 degrees for this particular embodiment of the bat holder, and the thickness of the spacer 27 is about 5/16ths of an inch.

With these dimensions, the spacer 27 will allow the bat holder of the present invention to be mounted on most typical chain-link fences 100 found at ball fields and playgrounds.

As mentioned previously, the bat holder of the present invention also includes an attachment clip 5. The attachment clip is mounted on the rear surface of the spacer 27.

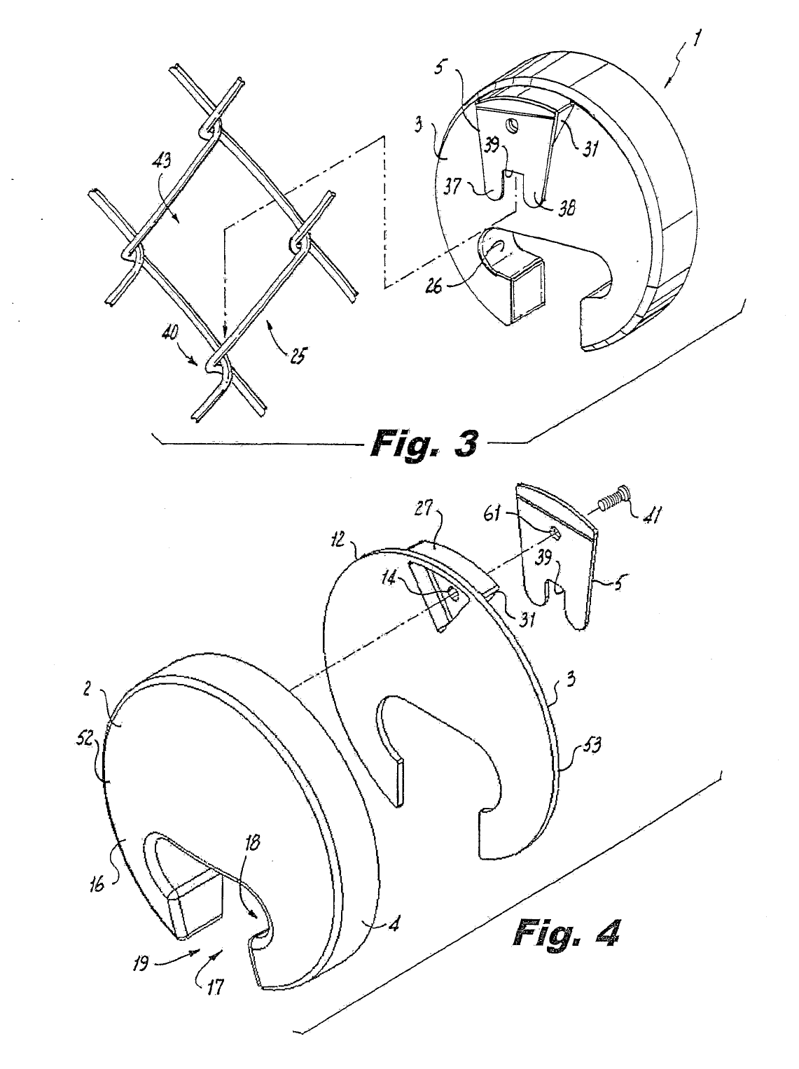

As shown in FIGS. 3-5 and 17-19 of the drawings, the attachment clip 5 may be a generally planar member that includes at its lower end a first tooth 37 and a second tooth 38 which are separated from each other to define therebetween a channel 39. The channel 39 is dimensioned to receive therein at least a portion of a twist 40 of the wire defining the links 25 of the chain-link fence 100 so that the bat holder of the present invention may be mounted on the chain-link fence 100, with the spacer 27 passing through or into the open space 43 of a link 25 and with the attachment clip 5 resting on a twist 40 of the link 25. As shown in FIG. 4, the attachment clip 5 may be secured to the spacer 27 by the screw 41 that holds the front and rear sections 2, 3 of the main body together and which also passes through an opening 61 formed through the thickness of the attachment clip 5. Alternatively, the attachment clip 5 may be secured to the spacer by adhesive or other fastening means.

In another preferred form of the present invention, and as particularly shown in FIGS. 6 and 7 thereof, the first and second contact surfaces 22, 23 may be angled backwardly from the front surface 16 toward the back surface 12 of the main body. The angle A of slope, as shown in FIG. 6, may be a few degrees, such as about 5 degrees to about 10 degrees, in a preferred form of the bat holder of the present invention. This slope provided to the contact surfaces 22, 23 helps prevent a bat 7 from becoming dislodged from the bat holder when the bat holder is mounted on the chain-link fence 100.

More specifically, if the fence 100 is struck or hit, or is shaken or vibrated, or is impacted, which quite often happens, such vibrations, of course, will be transmitted to the bat holder mounted on the fence 100. However, because the first and second contact surfaces 22, 23 are downwardly inclined rearwardly, towards the fence 100 when the bat holder is mounted thereon, a bat 7 held by the holder will tend to move within the pocket 17 in a direction toward the back surface 12 of the main body 1 and the fence 100 on which the bat holder is mounted, and not toward the front surface 16 of the main body 1 where it could have become inadvertently dislodged from the bat holder. Thus, the bat 7 will remain hanging from the pocket 17 of the bat holder and rest against the chain-link fence 100 on which the bat holder is mounted.

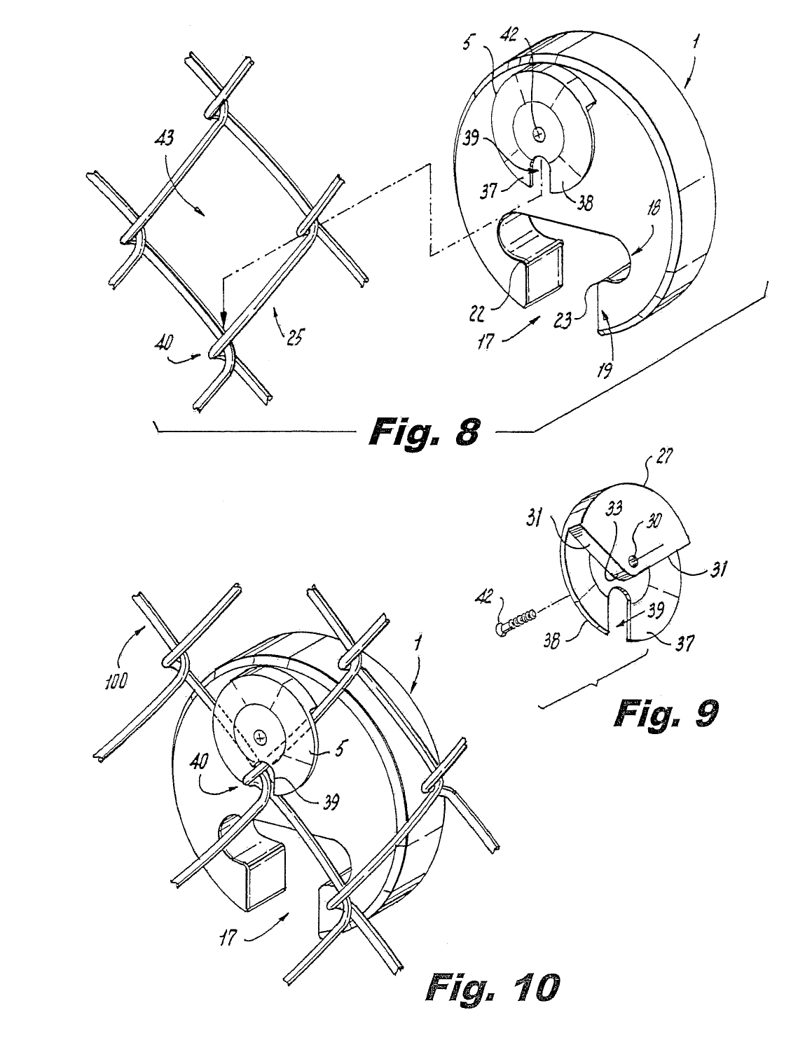

FIGS. 8-10 illustrate a second embodiment of the bat holder of the present invention. As in the embodiment described previously and shown in FIGS. 1-7, the bat holder of this second embodiment also includes a main body 1, a spacer 27, which is preferably wedge-shaped, and an attachment clip 5. However, in this embodiment, the attachment clip 5 is cylindrical in shape but still defined by a generally planar member having a first tooth 37 and a second tooth 38, or end portions, which are separated from each other to define a notch or channel 39 formed in the circumference of the cylindrical attachment clip 5 that, like the first embodiment, receives at least a portion of a twist 40 in the wire of the chain-link fence 100, as described previously with respect to the first embodiment shown in FIGS. 1-7 of the drawings.

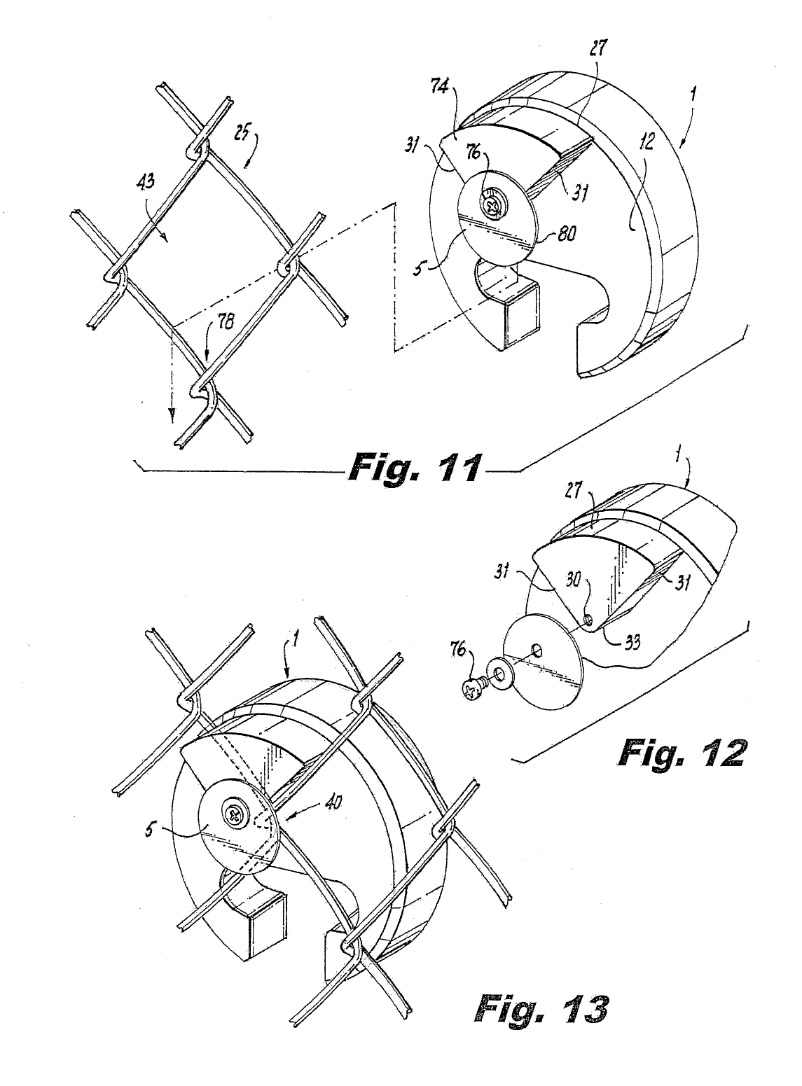

FIGS. 11-13 illustrate yet a third embodiment of the bat holder of the present invention. In this embodiment, the bat holder includes a main body 1, a spacer 27, which is preferably wedge-shaped, and an attachment clip 5. However, in this particular embodiment, the spacer 27 is made thicker than in the first and second embodiments described previously and respectively shown in FIGS. 1-7 and 8-10.

More specifically, the spacer 27 has a thickness which is preferably about three-quarters of an inch so that both wires defining a twist 40 in the chain-link fence rest on opposite angled surfaces 31 of the spacer 27, with the apex 33 of the wedge-shaped spacer being in proximity to where the two wires of the chain-link fence join at a twist 40. Furthermore, it is preferred if the angle of divergence of the two opposite surfaces 31 of the wedge-like spacer 27 is about 90 degrees.

Also, in this third embodiment, and as shown in FIGS. 11-13, the attachment clip 5 is in the form of a flat planar disk 80 (which may also be rectangular or polygonal) which is affixed to the rear surface 74 of the spacer near the apex 33 thereof by a screw 76, adhesive or other means and which overhangs the apex 33 a predetermined distance so that the upper portion 78 of the link twist 40 is held captive between the disk-shaped attachment clip 27 and the back surface 12 of the main body 1 to prevent the bat holder from becoming dislodged from the chain-link fence 100.

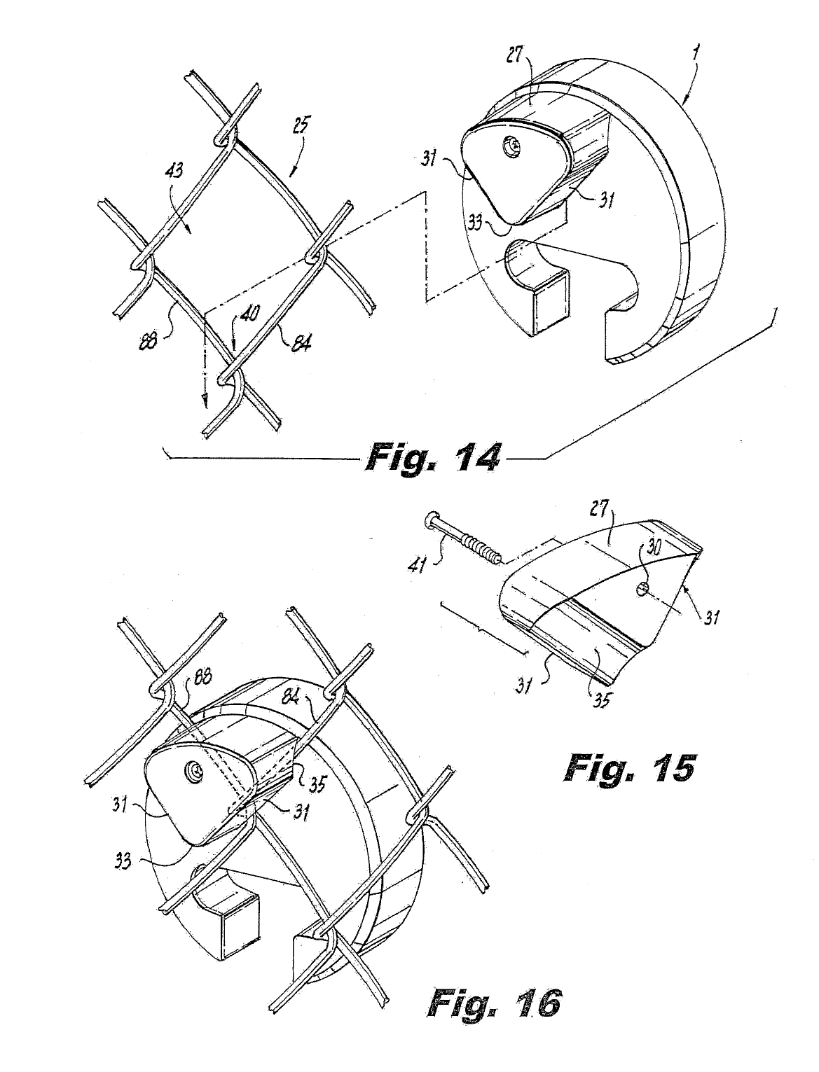

In yet a fourth embodiment of the present invention, the bat holder may include a main body 1, such as described before, as well as a wedge-like spacer 27, such as can be seen from FIGS. 14-16 of the drawings. The spacer 27 also functions as the attachment clip 5, as will be described below.

More specifically, the spacer 27 is relatively thick, that is, about one inch or more in thickness, and has angled contact surfaces 31 which diverge from an apex 33 at an angle of preferably about 90 degrees. However, in this fourth embodiment, the spacer 27 includes recesses 35 formed by portions of the contact surfaces 31 being beveled toward the back surface 12 of the main body 1. These recesses 35 formed on the angled contact surfaces 31 of the spacer 27 receive therein one or both of the angled wires 84, 88 which are twisted together at a link 25 in the chain-link fence. More specifically, each wire 84, 88 defining a twist 40 in a chain-link fence 100 may be received by a corresponding recess 35 formed in the spacer 27, or one wire 84 is received in one recess 35, and the other wire 88 rests against the flat portion of the opposite contact surface 31 of the spacer 27. The recesses 35 meet below the apex 33 of the wedge-like spacer 27 to provide a space therebelow so that the apex 33 of the spacer may hang slightly over the twist 40 in the wires 84, 88 of the chain-link fence 100 to secure at least a portion of the twist 40 between the spacer 27 and the back surface 12 of the main body. Thus, the spacer 27, with this particular configuration, also functions as the attachment clip 5 in the embodiments of the bat holder described previously.

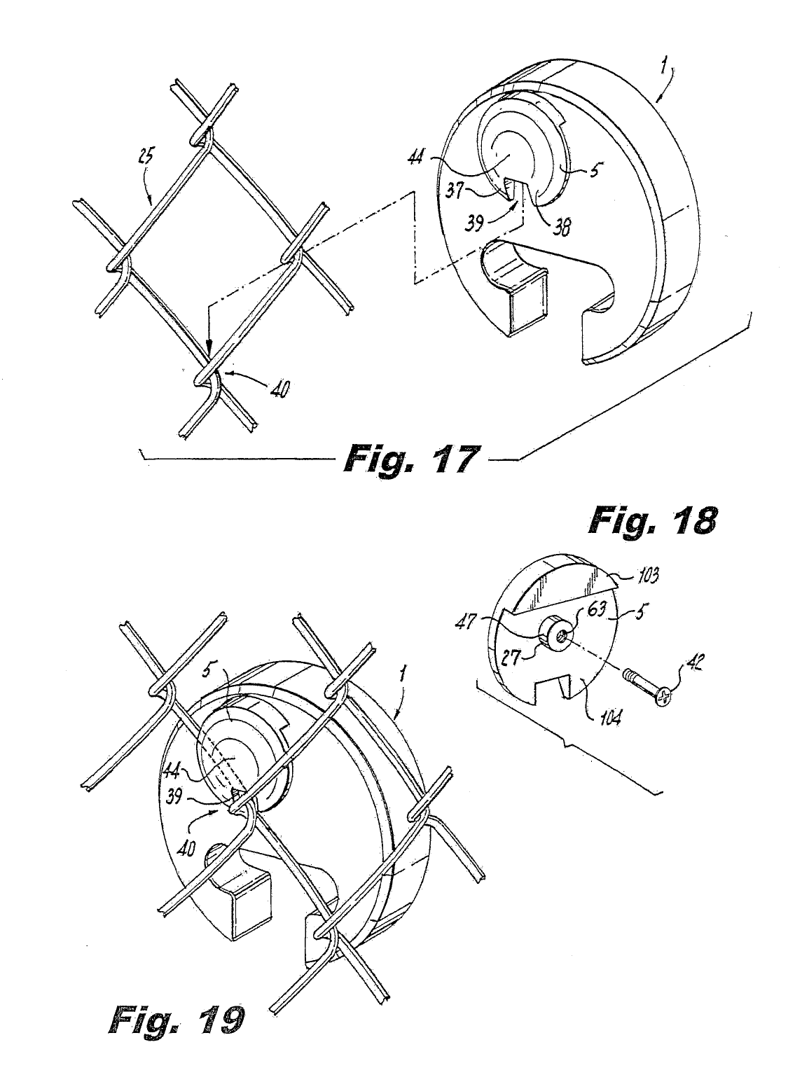

FIGS. 17-19 illustrate a fifth embodiment of the bat holder of the present invention. In this fifth embodiment, the bat holder includes a main body 1, a spacer 27 and an attachment clip 5. The spacer 27, in this embodiment, is in the form of a cylindrical post or boss 47 which extends outwardly from the front surface of the attachment clip 5 toward the back surface 12 of the main body 1. The boss 47 has formed therein a threaded central bore 63. A screw 42 passes through the thickness of the main body 1 and into the threaded bore 63 to secure the attachment clip 5 to the main body 1 of the bat holder. The preferred thickness of the spacer 27, which in this embodiment is the boss 47, is about one-quarter inch.

In this fifth embodiment of the bat holder, the attachment clip 5 is preferably in the form of a knob 44 having a slightly convex rear surface. The clip 5 may also include an extended portion 103, extending from the rear surface 104 of the clip towards the back surface 12 of the main body 1 and having the same thickness as the boss 47, to add stability and strength to the attachment clip 5 when it is affixed to the main body 1. The attachment clip 5 also includes a first tooth 37 and a second tooth 38 which are separated to define a channel 39 therebetween to receive a portion of the twist 40 in the wires of the chain-link fence which define a link 25, such as described previously with respect to the first embodiment of the present invention shown in FIGS. 1-7 of the drawings.

Either the attachment clip 5 or the spacer 27, or both, is particularly positioned on the main body 1 relative to the upper portion 18 of the pocket 17 in which the knob 46 of the bat resides so that the knob is preferably situated in alignment with the open space 43 of a link 25 in the fence below the twist 40 on which the bat holder is mounted so that no wires or twists of the fence interfere with the placement of the knob end 46 of the bat within the pocket 17. As can be seen in FIGS. 1, 2, 10, 13, 16 and 19 of the drawings, the upper portion 18 of the pocket 17 resides directly in front of the open space 43 of the link 25 either directly below or more than one link below the twist 40 on which the spacer 27 or clip 5 rests so that at least a portion of the knob 46 of the bat may extend at least partially into this open space 43 of the link without contacting the wires 84, 88 of the fence 100. Also, as can be seen from these figures, the back surface 12 of the main body 1 of the bat holder contacts and rests against portions of the interweaved wires 84, 88 that define the front of the fence, which adds stability to the bat holder and minimizes lateral movement thereof when the bat holder is mounted on the fence 100. This stability is further enhanced by the weight and moment arm of the baseball bat 7 held by the bat holder.

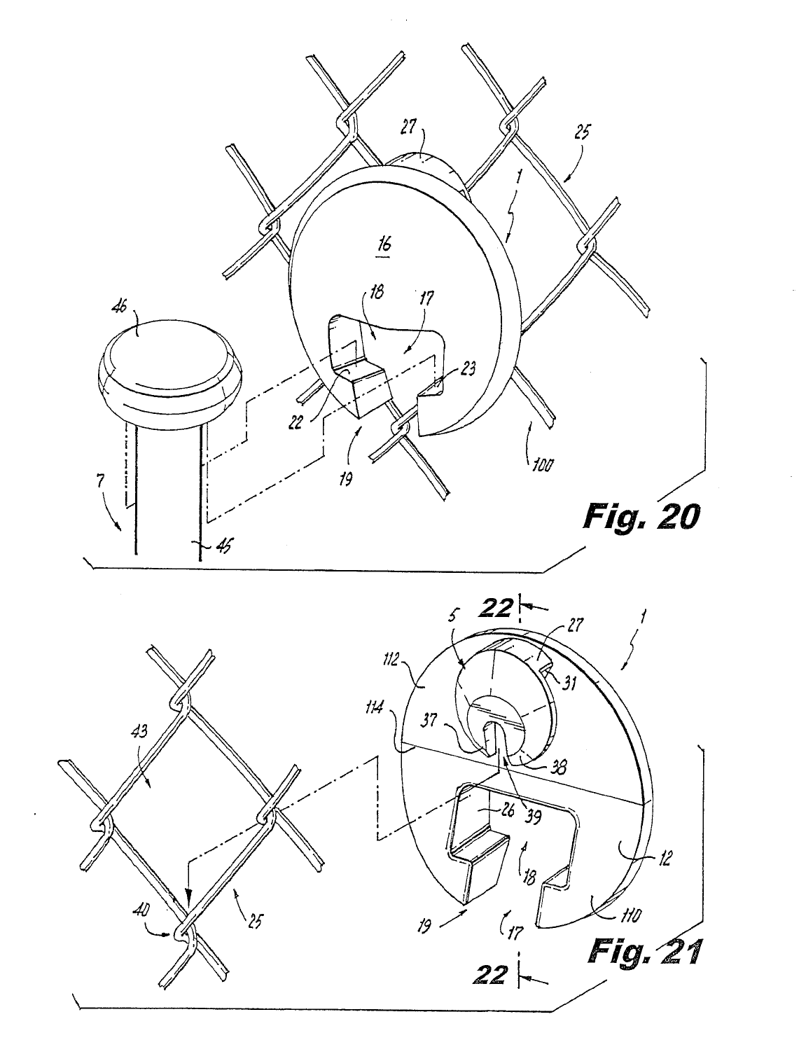

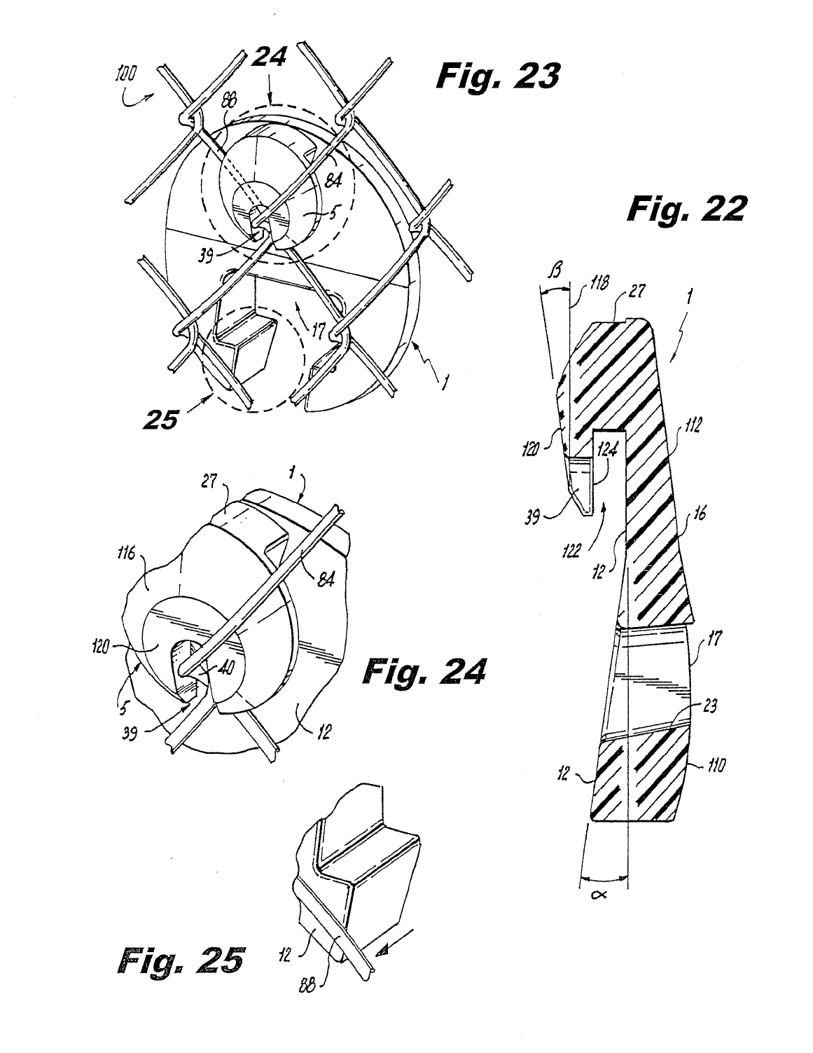

A sixth embodiment of the baseball bat support device is shown in FIGS. 20-25. In this preferred form of the baseball bat support device, a lower portion 110 of the main body 1 is made thicker than the upper portion 112 of the main body so that the overall weight of the baseball bat support device is concentrated more in the lower portion 110 than in the upper portion 112 of the main body 1. This weight distribution concentrated in the lower portion 110 of the main body 1 will assist in stabilizing the baseball bat support device as it rests on the chain-link fence 100. The greater thickness of the main body 1 in the lower portion 110 of the baseball bat support device can be seen in the cross-sectional view of FIG. 22. Also, it is evident from FIG. 22 that, in the preferred form, the main body 1 is formed as a solid piece of material, such as plastic, wood or the like, to provide the baseball bat support device with greater weight and strength.

Also, as can be seen from FIGS. 21-23, the lower portion 110 of the main body 1 is sloped outwardly from the rear surface 12 thereof, that is, towards the chain-link fence 100 on which the baseball bat support device is mounted. More specifically, and as can be seen from FIGS. 21 and 22, the plane in which the rear surface 12 of the lower portion 110 of the main body 1 resides diverges from the plane in which the rear surface 12 of the upper portion 112 of the main body resides by a particular angle a. This angle a is preferably in the range of between about 5 degrees and about 15 degrees, and is more preferably about 10 degrees. Stated another way, the respective planes in which the sections of the rear surface 12 reside over the upper and lower portions 112, 110 define between them an obtuse angle of preferably between about 165 degrees and about 175 degrees, and is more preferably about 170 degrees. As can be seen from FIGS. 21 and 22, the more outwardly sloping rear surface 12 of the lower portion 110 of the main body 1 is joined to the rear surface 12 of the upper portion 112 of the main body preferably at an angle and transversely across the main body, as depicted by transition line 114 in FIG. 21, although instead there may be a gradual, blended transition between these two portions of the rear surface 12 of the main body 1.

With such an outwardly diverging slope provided to the rear surface 12 of the lower portion 110, the main body 1 of the baseball bat support device will engage the surface of the chain-link fence 100 with its rear surface 12 at the lower portion 110 with greater force when the bat support device is mounted to the fence, rather than the bat support device merely hanging freely on the fence. This “wedging” action between the main body 1 and the fence 100 creates a stronger engagement between the rear surface 12 and the fence surface to provide the bat support device with greater stability when mounted on the fence and to minimize any rocking or swaying lateral movement of the bat support device on the fence.

The embodiment of the baseball bat support device of the present invention shown in FIGS. 20-25 includes certain features of the other embodiments described previously and shown in FIGS. 1-19, and like reference numbers designate generally similar or the same components. The bat support device of FIGS. 20-25 includes a spacer 27 (preferably wedge-shaped) and attachment clip 5, like the other embodiments, but in this particular version of the bat support device, the spacer 27 and attachment clip 5 are preferably formed integrally with the main body 1 and with a solid structure through its thickness, as can be seen in FIG. 22, to add strength and weight to the baseball bat support device. It can also be seen that the interior side walls 26 are flatter and less rounded than in the other embodiments previously described so that they define the upper portion 18 of the pocket 17 which receives the knob 46 of the baseball bat 7 with a more rectangular shape.

Also, as may be seen in FIGS. 22-25, the attachment clip 5 is formed in the shape of a knob, similar in many respects to the knob 44 of the embodiment of the bat support device shown in FIGS. 17-19, with a slightly convex rear surface 116. However, a portion of the convex rear surface 116 of the knob-like attachment clip 5 in the embodiment of the bat support device of FIGS. 20-25 is flattened and preferably sloped at a particular angle β towards the rear surface 12 of the main body 1 with respect to a plane 118 which is parallel to the plane in which the rear surface 12 of the upper portion 112 of the main body resides, thereby defining a flattened surface 120. This angle β of the plane in which sloped flattened surface 120 resides, measured with respect to the parallel plane 118 described previously, is preferably in the range of about 5 degrees and about 15 degrees, and is more preferably about 10 degrees.

It has been found by experimentation that the flattened surface 120 on the attachment clip 5 helps in maintaining the bat support device closer to the surface of the chain-link fence 100 on which it is mounted and with greater friction between the fence 100 and the bat support device. As can be seen in FIGS. 23-25, when the baseball bat support device is mounted on a chain-link fence 100, one linked wire 88 of the fence is received in the space 122 provided between the front surface 124 of the knob-shaped attachment clip 5 and the rear surface 12 of the upper portion 112 of the main body 1, and the other linked wire 84 of the fence engages and rests against the flattened portion 120 of the rear surface of the attachment clip 5. Thus, the flattened surface 120, and preferably one that is sloped downwardly, allows a better and closer fit between the chain-link fence 100 and the bat support device, and better accommodates the angle and direction the wires 84, 88 of the chain-link fence take as they diverge from a wire twist 40 on which the attachment clip 5 rests, and minimizes the possibility of the bat support device being skewed at an angle laterally by the wires 84, 88 of the chain-link fence 100 engaging the rear surface of the knob-like attachment clip 5. FIG. 25 shows how the wire 88 of the chain-link fence 100 engages the rear surface 12 of the lower portion 110 of the main body 1 to help stabilize the bat support device from movement when the device is mounted on the fence 100.

From the foregoing description and drawings, it should be realized that an important aspect of the baseball bat support device of the present invention is the various forms of the attachment clip 5 and spacer 27 used for mounting the main body 1 of the bat support device on the chain-link fence 100. Accordingly, it is envisioned to be within the scope of the present invention to use the attachment clips 5 and spacers 27 described herein to secure removably other devices to a chain-link fence, including baseball bat support devices having a different structure than that which is disclosed herein, a tennis racket holder, for example, devices to hold clothing (for example, a jacket) or a towel on a chain-link fence, devices for supporting a beverage, such a water bottle, on a chain-link fence, and generally other devices for holding an article, where it is desirable to attach the device to a chain-link fence.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A holder for a baseball bat, the holder being removably attachable to a chain-link fence made from interweaved wires defining a plurality of wire twist links and a plurality of open areas, the baseball bat to be held by the holder having a knob end and a shank portion connected to the knob end, the holder holding the baseball bat in an inverted disposition by the knob end, the holder comprising:
a main body, the main body having a front wall and a back wall disposed opposite the front wall, the main body having a bat receiving pocket foamed in at least the front wall thereof for removably receiving a portion of a baseball bat, the bat receiving pocket being defined by the main body with an upper pocket portion and a lower pocket portion situated adjacent the upper pocket portion and in communication therewith, the upper pocket portion having a width which is greater than the width of the lower pocket portion, the upper pocket portion being dimensioned to receive the knob end of a baseball bat, and the lower pocket portion being dimensioned to receive a portion of the shank of a baseball bat such that the holder may support the baseball bat in an inverted disposition at the knob end thereof;
a spacer affixed to the back wall of the main body and extending outwardly therefrom, the spacer having a predetermined depth so as to be partially receivable by an open area of the plurality of open areas of a chain-link fence when the holder is mounted thereto, with the back wall of the main body situated in close proximity to one or more wires of the chain-link fence; and
an attachment clip disposed on the spacer, the attachment clip engaging a portion of a chain-link fence when the holder is mounted thereto.

2. A holder for a baseball bat as defined by claim 1, wherein the main body includes an upper portion and a lower portion joined to the upper portion; and wherein the back wall includes a first section which is disposed on the upper portion and a second section which is disposed on the lower portion, each of the first and second sections of the back wall respectively generally residing in first and second planes, the second section of the back wall generally residing in the second plane diverging from the first section of the back wall generally residing in the first plane at a predetermined obtuse angle.

3. A holder for a baseball bat as defined by claim 1, wherein the attachment clip includes a peripheral edge, the peripheral edge having a notch formed therein, the notch at least partially receiving a wire twist link of the plurality of wire twist links of a chain-link fence when the holder is mounted thereto.

4. A holder for a baseball bat as defined by claim 1, wherein the spacer is generally wedge-shaped and includes a lower apex and first and second angled surfaces which mutually diverge from the lower apex, the spacer being oriented on the back wall of the main body such that the lower apex is disposed in a direction to face a wire twist link of the plurality of wire twist links of a chain-link fence when the holder is mounted thereto.

5. A holder for a baseball bat as defined by claim 1, wherein the main body includes a first contact surface and a second contact surface, the first and second contact surfaces being separated from each other and at least partially defining the upper pocket portion, the separated first and second contact surfaces being engageable by the knob end of a baseball bat and thereby supporting the baseball bat when the baseball bat is held by the holder.

6. A holder for a baseball bat as defined by claim 5, wherein the first and second contact surfaces of the upper pocket portion which are engageable by the knob end of a baseball bat are inclined rearwardly with a downward slope within the upper pocket portion in a direction from the front wall of the main body toward the back wall of the main body to help maintain the knob end of a baseball bat within the upper pocket portion when the baseball bat is held by the holder.

7. A holder for a baseball bat as defined by claim 1, wherein the main body includes an upper portion and a lower portion joined to the upper portion, each of the upper portion and the lower portion having a thickness, the thickness of the lower portion being greater than the thickness of the upper portion.

8. A baseball bat support device, which comprises:
a main body, the main body having a bat receiving pocket formed therein for removably receiving a portion of a baseball bat;
a spacer affixed to the main body; and
an attachment clip disposed on the spacer.

9. A baseball bat support device as defined by claim 8, wherein the main body includes a portion thereof defining the bat receiving pocket, the pocket defining portion of the main body defining the bat receiving pocket with an upper pocket portion and a lower pocket portion situated adjacent the upper pocket portion and in communication therewith, the upper pocket portion having a greater width than that of the lower pocket portion.

10. A baseball bat support device as defined by claim 9 in which a baseball bat to be held by the baseball bat support device includes a knob and a shank connected to the knob, wherein the upper pocket portion of the bat receiving pocket is dimensioned to receive therein the knob of the baseball bat, and wherein the lower pocket portion of the bat receiving pocket is dimensioned to receive a portion of the shank of the baseball bat.

11. A baseball bat support device as defined by claim 10, wherein the pocket defining portion of the main body includes a first contact surface and a second contact surface, the first and second contact surfaces being separated from each other, the knob of a baseball bat, when supported by the baseball bat support device, resting on the separated first and second contact surfaces.

12. A baseball bat support device as defined by claim 11, wherein the main body includes a front wall and a back wall disposed opposite the front wall; wherein the bat receiving pocket is formed in the front wall of the main body; and wherein the first and second contact surfaces on which the knob of a baseball bat may rest are angled downwardly of the main body in a direction from the front wall toward the back wall.

13. A baseball bat support device as defined by claim 12, wherein the first and second contact surfaces are angled downwardly in a direction from the front wall toward the back wall at a predetermined angle of slope, the predetermined angle of slope being between about five degrees and about fifteen degrees measured relative to a transverse plane which is perpendicular to a longitudinal plane passing through the main body.

14. A baseball bat support device as defined by claim 8, wherein the main body includes a front wall and back wall disposed opposite the front wall; and wherein the spacer is generally wedge-shaped and includes a lower apex and first and second angled surfaces which mutually diverge from the lower apex, the spacer being affixed to the back wall of the main body and extending outwardly therefrom.

15. A baseball bat support device as defined by claim 14, wherein the first and second angled surfaces of the spacer diverge from each other at, and define between them, a predetermined angle of divergence, the predetermined angle of divergence being selected to be one of about 70 degrees and about 90 degrees.

16. A baseball bat support device as defined by claim 8, wherein the spacer further defines the attachment clip and includes at least one recess formed in at least one of the first and second angled surfaces formed.

17. A baseball bat support device as defined by claim 8, wherein the main body includes a front wall and a back wall disposed opposite the front wall; and wherein the spacer includes a post extending outwardly from the back wall of the main body.

18. A baseball bat support device as defined by claim 8, wherein the attachment clip includes a generally planar member having a lower end, the lower end including a first projection and a second projection, the first and second projections being spaced apart from each other to define a channel therebetween.

19. A baseball bat support device as defined by claim 8, wherein the attachment clip includes a generally cylindrical member.

20. A baseball bat support device as defined by claim 19, wherein the generally cylindrical member of the attachment clip has formed in the circumference thereof a notch, the notch thereby defining the cylindrical member with spaced apart first and second end portions.

21. A baseball bat support device as defined by claim 19, wherein the attachment clip includes a rear surface having at least a portion thereof which is generally convex in shape.

22. A baseball bat support device as defined by claim 21, wherein the rear surface of the attachment clip includes a flattened portion.

23. A baseball bat support device as defined by claim 22, wherein the main body includes a back wall; and wherein the flattened portion of the attachment clip is sloped inwardly and downwardly in a direction toward the back wall of the main body.

24. A baseball bat support device as defined by claim 23, wherein at least a portion of the back wall resides in a plane; and wherein the flattened portion of the attachment clip is sloped at a predetermined angle measured relative to the plane in which the at least a portion of the back wall of the main body resides, the predetermined angle being between about five degrees and about fifteen degrees.

25. A baseball bat support device as defined by claim 8, wherein the attachment clip is in the form of a disc.

26. A baseball bat support device as defined by claim 8, wherein the main body includes an upper portion and a lower portion joined to the upper portion, each of the upper portion and the lower portion having a thickness, the thickness of the lower portion being greater than the thickness of the upper portion.

27. A baseball bat support device as defined by claim 8, wherein the main body includes a back wall; wherein the main body includes an upper portion and a lower portion joined to the upper portion; and wherein the back wall includes a first section which is disposed on the upper portion and a second section which is disposed on the lower portion, each of the first and second sections of the back wall respectively generally residing in first and second planes, the second section of the back wall generally residing in the second plane diverging from the first section of the back wall generally residing in the first plane at a predetermined obtuse angle.

28. A baseball bat support device as defined by claim 27, wherein the predetermined obtuse angle defined by and between the first section of the back wall and the second section of back wall is between about 165 degrees and about 175 degrees.
